(19) United States
(12) Patent Application Publication
(10) Pub. No.: US 2007/0031576 A1
(43) Pub. Date: Feb. 8, 2007

(54) Process for the preparation of whole soybean milk and curd comprising multiple steps of ultra high-pressure homogenization of soybean

(75) Inventors: Sang Kyun Cho, Yongin-si, Kyungki-do (KR); Seung Hoon Oh, Osan-si, Kyungki-do (MD)

Correspondence Address: SUGHRUE MION, PLLC, 2100 PENNSYLVANIA AVENUE, N.W., SUITE 800, WASHINGTON, DC, 20037, US

(73) Assignee: HANMI WHOLE SOYMILK CO., LTD., Pyeongtaek-si, Kyungki-do (KR)

(21) Appl. No.: 10/595,131

(22) PCT Filed: Sep. 2, 2004
(86) PCT No.: PCT/KR04/02215

§ 371 Date: Mar. 2, 2006

(30) Foreign Application Priority Data
Sep. 2, 2003 (KR) 1020030061188
Sep. 2, 2003 (KR) 10-2003-0061188

(51) Int. Cl. A23L 1/20

(52) U.S. Cl. 426/634

(57) ABSTRACT

A whole soybean milk or curd is prepared by milling soybeans and homogenizing the milled soybeans via at least two steps of ultra-high pressure micronization, wherein the pressure applied at each step of the ultra-high pressure micronization is at least 500 bar, and the total cumulative sum of the pressures applied during the steps of the ultra-high pressure micronization is at least 2,000 bar.

### FIELD OF THE INVENTION

The present invention relates to a process for preparing a highly nutritious whole soybean milk and curd, without generating any soybean curd refuse.

### BACKGROUND OF THE INVENTION

A conventional process for preparing soybean milk or curd includes the steps of heating and milling boiled soybeans, water-soaked raw soybeans or soybean powders, and pressing the resulting slurry to obtain soybean milk. In such conventional process, about one-third by weight of soybean feed is discarded as a solid residue, wasting a large amount of nutritious components of soybean such as fibroid materials, lipids and inorganic materials.

Hitherto, various attempts have been made to prevent the loss of nutritious components during the soybean milk or curd preparation; e.g., by way of: recovering the nutritious components in a soybean curd refuse with an enzyme (Korean Patent Publication No. 1994-002528); decomposing the soybean curd refuse with a mixture of enzymes (Korean Patent Laid-open Publication No. 2001-41120); subjecting the soybean curd refuse to a combination of ultrasonic and heat treatments (Korean Patent Nos. 41494 and 59907); and reducing the soybean curd refuse with a high temperature/high pressure treatment (Korean Patent No. 86038).

However, the above methods are not suitable for commercialization because they tend to produce a soybean milk which contains large particles therein, or which has a disagreeable taste or flavor resulting from retreatment of the soybean curd refuse. Further, the methods employing the enzymatic decomposition technique are not economical since they use expensive enzymes.

On the other hand, various high pressure processes have been developed to micronize particles in the soybean milk, such as a high-pressure homogenization of a slurry prepared by milling soybeans in water by applying thereto a pressure greater than 100 kg/cm² (U.S. Pat. No. 4,137,339), a process applying a pressure to a soybean slurry dispersed in an excess amount of water (Korean Patent Publication No. 1992-5933, U.S. Pat. No. 3,901,978, and Korean Patent Laid-open Publication No. 2002-92272), and a process subjecting milled soybeans to a high-temperature heat treatment and then micronizing the same under high pressure (Japanese Patent Laid-open Publication No. 1984-210861).

These processes produce soybean milk containing particles having an average particle diameter of about 50 μm and generate solid residues. Further, such processes have the problems of insufficient homogeneous micronization of soybean milk particles, unsatisfactory texture of the prepared soybean curd, and low productivity.

Accordingly, the present inventors have endeavored to develop an economical and efficient process for preparing soybean milk and curd, which does not require extra steps such as enzymatic treatment, acid treatment and/or dispersion in an excessive amount of water, while generating no soybean curd refuse; and have developed a novel process for preparing a whole soybean milk by performing at least two steps of ultra-high pressure micronization, wherein the total cumulative sum of pressures applied during the steps of the ultra-high pressure micronization is at least 2,000 bar. This inventive process is capable of providing a highly nutritious and homogeneous whole soybean milk containing particles having an average particle diameter of at most 40 μm as well as a whole soybean curd having excellent texture.

### SUMMARY OF THE INVENTION

Accordingly, it is a primary object of the present invention to provide a process for preparing a whole soybean milk and curd containing homogeneously micronized soybean particles while preserving the entire nutrients of soybeans, which employs no extra process steps such as an enzymatic treatment and does not generate a soybean curd refuse.

In accordance with the foregoing object of the present invention, there are provided a process for preparing a whole soybean milk, comprising the steps of milling soybeans and homogenizing the milled soybeans by performing at least two steps of ultra-high pressure micronization, wherein the pressure applied at each step of the ultra-high pressure micronization is at least 500 bar, and the total cumulative sum of the pressures applied during the steps of the ultra-high pressure micronization is at least 2,000 bar; and a process for preparing a whole soybean curd comprising the steps of adding an coagulating agent to the prepared whole soybean milk.

### BRIEF DESCRIPTION OF THE DRAWINGS

The above and other objects and features of the present invention will become apparent from the following description of the invention, when taken in conjunction with the accompanying drawings, in which:

FIG. 1 provides a diagram showing the process of the present invention for preparing a whole soybean milk and a comparative process disclosed in Japanese Patent Laid-open Publication No. 1984-210861;

FIG. 2a illustrates the particles of the milled soybeans; and FIGS. 2b to 2d show particles of the whole soybean milk obtained after the 1^{st}, 2^{nd} and 3^{rd} ultra-high pressure micronization steps of the inventive process, respectively; and

FIG. 3 discloses the results of particle size analysis conducted on the soybean milk samples obtained after the respective ultra-high pressure micronization steps of the present invention.

### DETAILED DESCRIPTION OF THE INVENTION

As used herein, the term “whole soybean milk” and “whole soybean curd” mean the soybean milk and curd preserving the whole nutritious components of soybeans, prepared from whole or peeled soybean grains without losing or wasting any useable part of a soybean or without generating any soybean refuse.

In the present invention, the whole soybean milk and curd having the desired particle size, viscosity and textural property are prepared by heating peeled and/or water-soaked soybeans, mechanically milling the heated soybeans, removing undesirable odors from the milled soybeans, and homogenizing soybean particles by performing at least two steps of ultra-high pressure micronization.

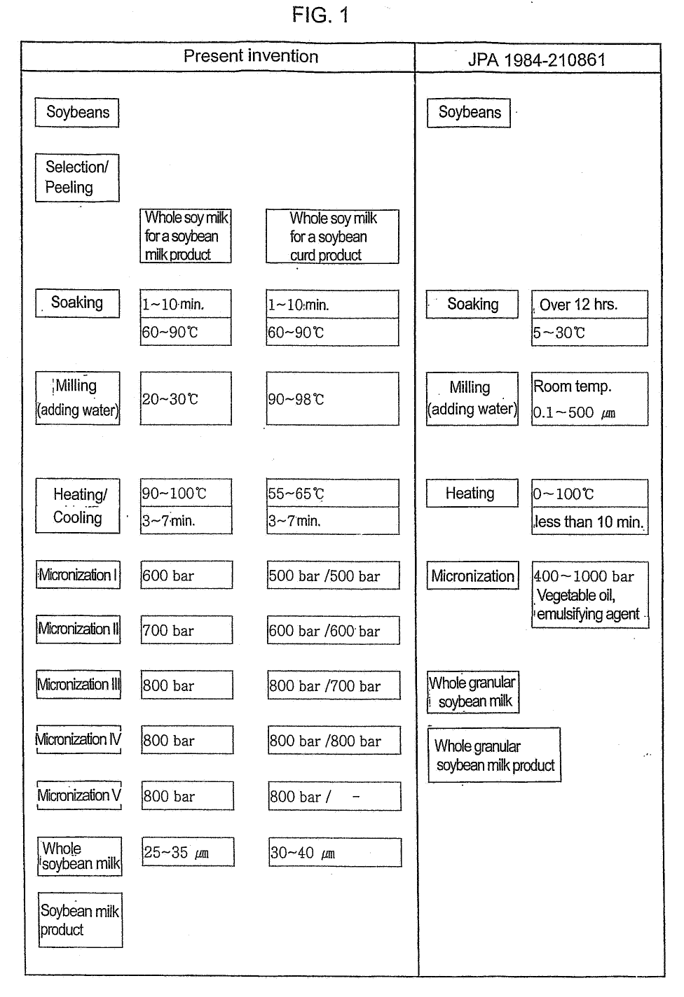

The process of the present invention may be conducted according to the diagram shown in the left side of FIG. 1, which also shows a comparative process disclosed in Japanese Patent Laid-open Publication No. 1984-210861 employing a high-pressure homogenization process of soybeans.

Step 1: Pretreatment

Proper whole or peeled soybean grains selected and washed, which may be carried out in accordance with a conventional method.

Step 2: Soaking

The whole or peeled soybean grains are dried with hot air, or the whole soybean grains are peeled by abrasion without drying. In order to enhance the extraction of soybean proteins, the resulting soybean grains are soaked in 2 to 3 fold volume of water having a temperature ranging from 60 to 90° C. for 1 to 10 minutes, then the water is removed.

Step 3: Softening and Milling

In this step, the soaked soybeans are subjected to heat-softening and mechanical milling. Specifically, the soaked soybeans are milled with a mechanical milling apparatus such as a chopper mill or colloid mill, while adding water having a temperature ranging from 20 to 30° C. or hot water having a temperature ranging from 90 to 98° C., in an amount to adjust the solid content of the resulting slurry to 10±3%. When the room-temperature water is used in the milling step, the milled slurry is softened by heat treatment. Such heat-softening of soybean particles before or after the milling step enhances the efficiencies of the milling and subsequent micronization processes. The quality of the final soybean milk product may be controlled by varying the conditions of the milling process. For instance, these processes may be carried out under the following conditions.

In accordance with a preferred embodiment of the subject invention, the soaked soybeans are milled by a chopper mill, while adding water having a temperature of 25±5° C. in an amount to adjust the solid content of the resulting slurry to 10±3%. The resulting slurry is maintained at 95±5° C. for 3 to 7 minutes to soften the soybean particles and also to inactivate lipoxidases contained in the slurry, thereby removing bad odors from the resulting soybean milk. The combined use of these softening and milling processes with subsequent ultra-high pressure micronization process yields a homogeneously micronized whole soybean milk containing particles having an average particle diameter ranging from 25 to 35 μm. Accordingly, these softening and milling processes are suitable for preparing a soybean milk useful for high-quality soybean milk products.

In another preferred embodiment of the subject invention, the soaked soybeans are milled by a chopper mill, while adding hot water of 90-98° C. in an amount to adjust the solid content of the resulting slurry to 10±3%. The resulting slurry is maintained at the same temperature for 3 to 7 minutes to inactivate the lipoxidases for the purpose of deodorizing the resulting soybean milk. In order to further soften the soybean particles, sodium hydrogen carbonate may be added to the soaked soybeans together with the hot water. If necessary, the resulting slurry may be cooled to a temperature ranging from 55 to 65° C. and maintained for 3 to 7 minutes. The combined use of these softening and milling processes with subsequent ultra-high pressure micronization process yields a homogeneously micronized whole soybean milk containing particles having an average particle diameter ranging from 30 to 40 μm. Accordingly, these softening and milling processes are suitable for preparing soybean milk which can be used in producing high-quality soybean curd products.

Step 4: Preparation of a Whole Soybean Milk By Ultra-High Pressure Micronization

The soybean slurry prepared in Step 3 is transferred to a sterilizing/cooling machine and maintained at a temperature ranging from 60 to 95° C. Such soybean slurry is homogeneously micronized with a homogenizer by performing two to six steps, preferably, three to five steps of ultra-high pressure micronization, wherein the pressure applied at each step of the ultra-high pressure micronizations ranges from 500 to 1,500 bar, preferably, 500 to 1,000 bar, and the resulting whole soybean milk contains particles having an average particle diameter ranging from 20 to 40 μm. Here, the total cumulative sum of the pressures applied during the steps of the ultra-high pressure micronization is at least 2,000 bar, preferably, 2,400 to 5,000 bar. When the pressure applied at each step of the ultra-high pressure micronization is less than 500 bar or the total cumulative sum of the pressures applied is less than 2,000 bar, a sufficient homogeneous micronization effect cannot be achieved even when multiple micronization steps are employed.

The pressures applied in each step of the ultra-high pressure micronization can be appropriately chosen by taking into consideration the softening and milling conditions at Step 3 and the type of the desired final product, e.g., soybean milk and soybean curd (hard soybean curd, soft soybean curd, uncurdled soybean curd, etc.).

Further, it is preferred to keep the processed soybean milk at a temperature not exceeding 98° C. during the ultra-high pressure micronization in order to prevent the discoloration or excessive viscosity increase in the resulting soybean milk. For example, when the ultra-high pressure micronization is carried out in five steps, the processed soybean milk obtained after the third step thereof is preferably cooled to a temperature ranging from 85±5° C. before carrying out the next step.

Specifically, a process comprising the steps of milling soybeans at a room temperature, adjusting the resulting soybean slurry to 90±5° C. by adding hot water of 90-100° C. thereto, and performing multi-step micronization is suitable for the preparation of less viscous soybean milk having more micronized particles. In such process, since the degree of initial softening of the soybean particles is satisfactory, it is preferable to apply a relatively low pressure in the first and the second steps of the micronization process, apply a relatively high pressure in the third step, cool the resulting soybean milk to 85±5° C., and then micronize the obtained soybean milk while maintaining ulta-high pressures (e.g., 600 bar-700 bar-800 bar-cooling-800 bar-800 bar).

Meanwhile, a process comprising the steps of milling soybeans while adding a hot water of 90-100° C. thereto, cooling the resulting soybean slurry to 55 to 65° C., and performing multi-step micronization is suitable for the preparation of deodorized and less viscous soybean milk. In this case, it is preferable to increase stepwise the pressure applied at each step of the micronization process (e.g., 500 bar-600 bar-700 bar-800 bar).

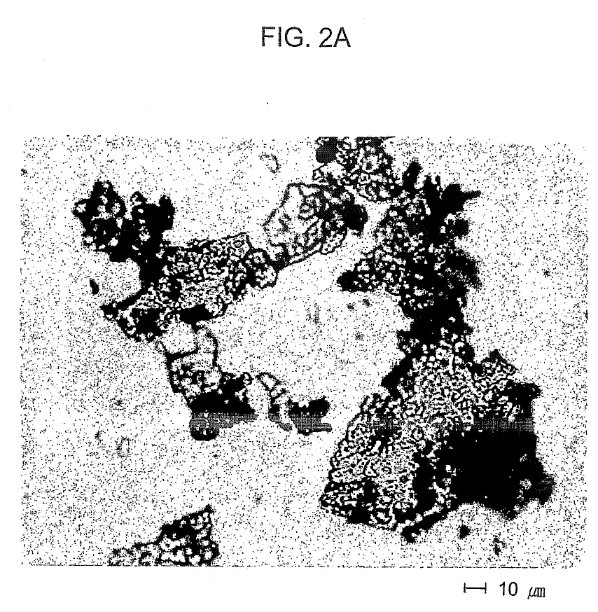

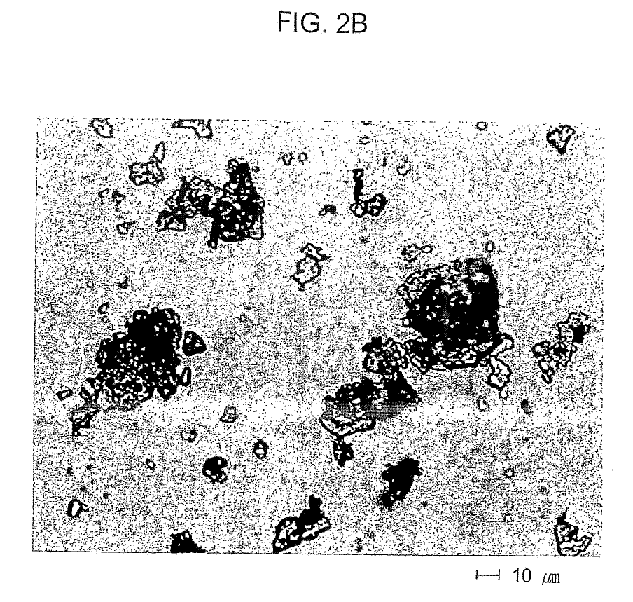

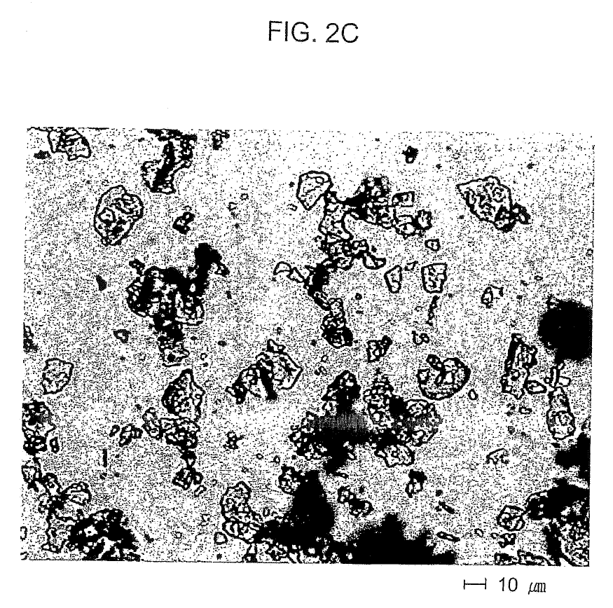

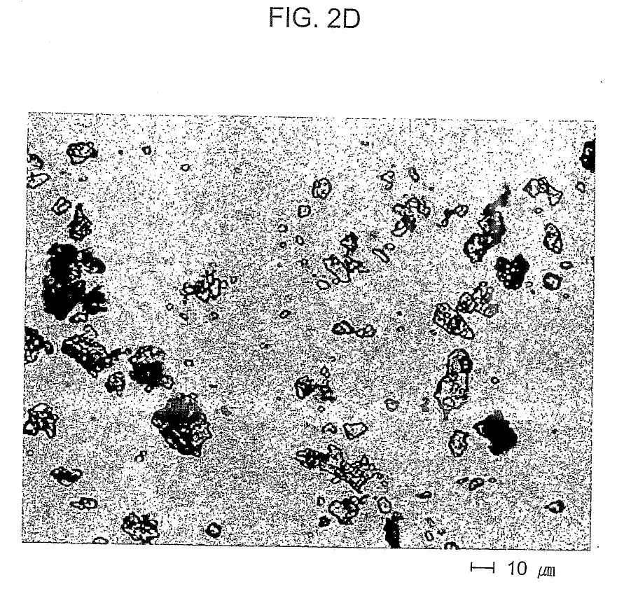

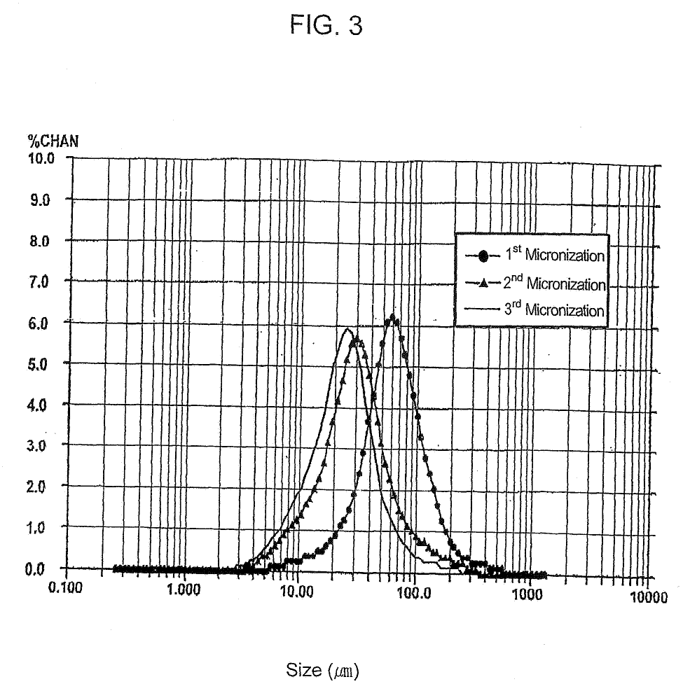

The whole soybean milk prepared in accordance with the above ultra-high pressure micronization process contains finely micronized particles, as a result of micronizing the soybean particles in a closely controlled stepwise manner (see FIGS. 2a to 2d), and shows a normal distribution of evenly micronized particles (see FIG. 3).

Step 5: Preparation of Whole Soybean Milk and Curd Products

As further illustrated below, various types of whole soybean milk and curd products may be made in accordance with the present invention.

5-1) Whole Soybean Milk Products

In order to produce a whole soybean milk product which can be stored at a room temperature in a liquid form, the whole soybean milk prepared as above is mixed with a trace amount of a food additive, and the mixture is subjected to a high temperature sterilization for a short period of time, filling and packaging to obtain a whole soybean milk product having soybean particles having an average particle diameter ranging from 25 to 35 μm and a viscosity ranging from 30 to 120 cps.

Further, flavors may be also added to the whole soybean milk in order to enhance the flavor or taste of the whole soybean milk product. Exemplary flavors are fruit, fruit puree, fruit juice, fruit concentrate, fruit powder and a mixture thereof.

Moreover, as desired, a suitable amount of milk calcium or an extract or powder of various nutritious substances may be added to the whole soybean milk. Exemplary natural substances for this purpose include sesame, black sesame, carrot, spinach, green tea, red tea, mulberry leaves, arrowroot, herbs, ginseng, red ginseng, Chinese bellflower, and the like.

5-2) Whole Soybean Curd Products

As described above, various whole soybean curd products such as hard soybean curd, soft soybean curd and uncurdled soybean curd may be made from the whole soybean milk prepared as above. If necessary, suitable flavors or nutritious substances exemplified above may be also added to the whole soybean milk during the process of making the whole soybean curd products.

5-2-1) Hard Soybean Curd

The whole soybean milk prepared as above is cooled to a temperature of 80±5° C. by passing it through a sterilizing/cooling machine, and then subjected to conventional bean curd preparation processes, e.g., addition of a coagulating agent, stirring, coagulation, pressing, cutting, packing, sterilization and cooling, to obtain a hard soybean curd product.

5-2-2) Soft Soybean Curd or Uncurdled Soybean Curd

The whole soybean milk prepared as above is cooled to a temperature of 15±5° C. by passing it through a cooling machine, and then subjected to conventional soft or uncurdled bean curd preparation processes, e.g., addition of a coagulating agent, filling, heating at 80° C., coagulation, sterilization and cooling, to obtain a soft soybean curd or uncurdled soybean curd product.

As described above, the inventive process is capable of producing highly nutritious and homogeneous whole soybean milk and whole soybean curd products having good texture, without requiring extra steps such as enzymatic treatment, acid treatment and dispersion in an excessive amount of water, and without generating any soybean waste or refuse; and, accordingly, the process of the present invention is highly economical and advantageous in that it can be easily industrialized to achieve a mass production of the desired soybean products.

The following Examples are intended to further illustrate the present invention without limiting its scope.

### EXAMPLE 1

Whole soybean grains were selected, dried and peeled by abrasion. 100 kg of the peeled soybean grains was soaked in 75° C. water for 5 minutes. The soak water was discharged and contaminants were removed. The soaked soybeans were transferred to a chopper mill and subjected to milling with stirring, while adding thereto 770 kg of 25° C. water. The resulting soybean slurry was heated in a sterilizer at 98° C. for 5 minutes, and then, cooled to 90° C. The milled soybean slurry was micronized through an ultra-high pressure micronization process consisting of five steps of micronization. Specifically, a micronization pressure of 600 bar at the 1^{st} step, 700 bar at the 2^{nd} step, and 800 bar at the 3^{rd} step were applied to the milled soybean slurry, and then, the slurry was cooled to 85° C. in a cooler. Sequentially, a micronization pressure of 800 bar at the 4^{th} step and 800 bar at the 5^{th} step were applied to the slurry to obtain whole soybean milk which had soybean particles having an average particle size of 30 μm, a viscosity of 60 cps and a solid content of 10.1%.

FIGS. 2a to 2d display the particle sizes of the milled soybean and whole soybean milk obtained during the ultra-high pressure micronization process, wherein FIG. 2a represents the particles of the milled soybean; and FIGS. 2b to 2d, particles of whole soybean milk obtained after the 1^{st} (600 bar), 2^{nd} (700 bar) and 3^{rd} (800 bar) micronization steps, respectively. It can be seen from FIGS. 2a to 2d that the soybean milk particle size decreases in steps during the multi-step ultra-high pressure micronization process.

To the whole soybean milk thus obtained were added additives such as saccharides and flavors. The resulting mixture was filled in a bottle or can at 90° C., and retorted by sterilizing at 121° C. for 21 minutes to obtain a whole soybean milk product which has a viscosity of 95 cps and contains soybean particles having an average particle size of 31 μm. This product can be stored at room temperature for more than 4 months.

### EXAMPLE 2

120 kg of whole soybean grains was soaked in 85° C. water for 10 minutes. The soak water was discharged and contaminants were removed. The soaked soybeans were transferred to a chopper mill and subjected to milling with stirring, while adding thereto 786 kg of 98° C. water and 230 g of sodium hydrogen carbonate. The resulting soybean slurry was cooled to 60° C. in a cooler, and micronized through an ultra-high pressure micronization process consisting of four steps of micronization: applying 500 bar at the 1^{st} step, 800 bar at the 2^{nd} step, 800 bar at the 3^{rd} step, and 800 bar at the 4^{th} step, to obtain whole soybean milk which contains soybean particles having an average particle size of 33 μm and has a viscosity of 50 cps and a solid content of 11%.

To the whole soybean milk thus obtained were added 0.05% sucrose fatty acid ester as an emulsifying agent and additives such as saccharides and flavors. The resulting mixture was sterilized at 147° C. for 10 seconds and subjected to stabilizing micronization at 250 bar. The resulting soybean milk was cooled to 25° C. and packaged. The whole soybean milk product thus obtained contained soybean particles having an average particle size of 31 μm, had a viscosity of 80 cps and a storage life at room temperature of more than 4 months.

### EXAMPLE 3

Whole soybean grains were selected, dried and peeled by abrasion. 80 kg of the peeled soybean grains was soaked in 75° C. water for 5 minutes. The soak water was discharged and contaminants were removed. The soaked soybeans were transferred to a chopper mill and subjected to milling with stirring, while adding thereto 790 kg of 96° C. water. The resulting soybean slurry was kept for 7 minutes to remove the soybean odor caused by lipoxidase. The resulting soybean slurry was micronized through an ultra-high pressure micronization process consisting of five steps of micronization: applying 500 bar at the 1^{st} step, 600 bar at the 2^{nd} step, 800 bar at the 3^{rd} step, 800 bar at the 4^{th} step, and 800 bar at the 5^{th} step, to obtain whole soybean milk which contains soybean particles having an average particle size of 32 μm and has a viscosity of 120 cps and a solid content of 8.2%.

The whole soybean milk thus obtained was immediately transferred to soybean curd preparation lines and filled into a coagulation tank at 82° C. A suitable amount of magnesium chloride was added thereto and the mixture was stirred slowly. After 5 minutes, the mixture was examined for the coagulation state and then subjected to pressing, cooling, cutting and packaging to obtain a hard soybean curd having a solid content of 22%.

### EXAMPLE 4

130 kg of whole soybean grains was soaked in 85° C. water for 5 minutes. The soak water was discharged and contaminants were removed. The soaked soybeans were transferred to a chopper mill, subjected to milling with stirring, while adding thereto 790 kg of 96° C. water, and then kept for 7 minutes. The resulting soybean slurry was cooled to 65° C. in a cooler, and micronized through an ultra-high pressure micronization process consisting of four steps of micronization: applying 800 bar at the 1^{st} step, 800 bar at the 2^{nd} step, and 800 bar at the 3^{rd} step, to obtain whole soybean milk which contains soybean particles having an average particle size of 30 μm and has a viscosity of 107 cps and a solid content of 12.6%.

When the whole soybean milk samples obtained at each step of the above ultra-high pressure micronization process were analyzed by a laser diffraction particle size analyzer (Shimadzu, Japan), the average particle size of the soybean particles was 79.5 μm after the 1^{st} micronization step, 41.2 μm after the 2^{nd} micronization step, and 30.1 μm after the 3^{rd} micronization step, as shown in FIG. 3. These results exhibits that the average particle size of the soybean particles reduced significantly by repeating the steps of ultra-high pressure micronization.

The whole soybean milk thus obtained was immediately cooled to 50° C., transferred to a soybean curd preparation apparatus and a suitable amount of milky magnesium coagulant was added thereto. The mixture was subjected to packaging, heating up to 85° C. and cooling to obtain a soft soybean curd having a solid content of 13%.

While the invention has been described with respect to the above specific embodiments, it should be recognized that various modifications and changes may be made to the invention by those skilled in the art which also fall within the scope of the invention as defined by the appended claims.

What is claimed is:

1. A process for preparing a whole soybean milk without generating any soybean refuse, comprising the steps of: milling soybeans and homogenizing the milled soybeans by performing at least two steps of ultra-high pressure micronization, wherein the pressure applied at each step of the ultra-high pressure micronization is at least 500 bar, and the total cumulative sum of the pressures applied during the steps of the ultra-high pressure micronization is at least 2,000 bar.

2. The process of claim 1, wherein the ultra-high pressure micronization is performed in 2 to 6 steps.

3. The process of claim 1, wherein the pressure applied at each step of the ultra-high pressure micronization ranges from 500 to 1,500 bar.

4. The process of claim 1, wherein the total cumulative sum of the pressures applied during the steps of the ultra-high pressure micronization ranges from 2,400 to 5,000 bar.

5. The process of claim 1, wherein the whole soybean milk contains particles having an average particle diameter of at most 40 μm.

6. The process of claim 1, wherein the whole soybean milk contains particles having an average particle diameter ranging from 20 to 35 μm.

7. The process of claim 1, which comprises the steps of:
1) soaking soybeans in water having a temperature ranging from 60 to 90° C. for a period from 1 to 10 minutes;
2) milling the soaked soybeans to obtain a soybean slurry; and
3) homogenizing the soybean slurry at a temperature ranging from 60 to 95° C. by performing two to six steps of ultra-high pressure micronization, wherein the pressure applied at each step of the ultra-high pressure micronization ranges from 500 to 1,500 bar, and the total cumulative sum of the pressures applied during the steps of the ultra-high pressure micronization is at least 2,000 bar, to obtain the whole soybean milk containing particles having an average particle diameter ranging from 20 to 40 μm.

8. The process of claim 7, wherein step 2) is conducted by milling the soaked soybeans while adding water having a temperature ranging from 20 to 30° C., and keeping the resulting slurry at a temperature ranging from 90 to 100° C. for 3 to 7 minutes.

9. The process of claim 7, wherein step 2) is conducted by milling the soaked soybeans while adding water having a temperature ranging from 90 to 98° C., and keeping the resulting slurry at a temperature ranging from 55 to 65° C. for 3 to 7 minutes.

10. A process for preparing a whole soybean curd, comprising the step of adding a coagulating agent to the whole soybean milk prepared by the process of any one of claims 1 to 9.

11. The process of claim 10, wherein the whole soybean curd is a hard soybean curd, soft soybean curd or uncurdled soybean curd.

12. A process for preparing a whole soybean milk product, comprising the steps of mixing the whole soybean milk prepared by the process of any one of claims 1 to 9 with a food additive, and subjecting the resulting mixture to the steps of stabilization, filling, sterilization and cooling.

13. A process for preparing a whole soybean curd product, comprising the steps of mixing the whole soybean milk prepared by the process of any one of claims 1 to 9 with a coagulating agent and a food additive to obtain a coagulated mixture, and subjecting the coagulated mixture to the steps of heating, sterilization and cooling.
